(19) United States
(12) Patent Application Publication
(10) Pub. No.: US 2025/0193806 A1
(43) Pub. Date: Jun. 12, 2025

(54) ELECTRONIC DEVICE AND INTEGRATED CONTROL METHOD FOR MLO AND TAS

(71) Applicant: Samsung Electronics Co., Ltd., Suwon-si (KR)

(72) Inventor: Junsu CHOI, Suwon-si (KR)

(21) Appl. No.: 19/056,194

(22) Filed: Feb. 18, 2025

Related U.S. Application Data
(63) Continuation of application No. PCT/KR2023/010595, filed on Jul. 21, 2023.

(30) Foreign Application Priority Data
Aug. 23, 2022 (KR) 10-2022-0105645
Sep. 21, 2022 (KR) 10-2022-0119648

(51) Int. Cl. H04W 52/36; H04W 28/22; H04W 56/00; H04W 76/15; H04W 84/12

(52) U.S. Cl. CPC H04W 52/36; H04W 28/22; H04W 56/0045; H04W 76/15; H04W 84/12

(57) ABSTRACT

An electronic device is provided. The electronic device includes at least one wireless communication circuitry configured to transmit and receive wireless signals, memory storing one or more computer programs, and one or more processors communicatively coupled to the at least one wireless communication circuitry and the memory, wherein the one or more computer programs include computer-executable instructions that, when executed by the one or more processors individually or collectively, cause the electronic device to verify a time-averaged specific absorption rate (SAR) (TAS) backoff regulation value allocated to a multi-link operation (MLO) for a time window, and based on the TAS backoff regulation value, determine a link combination to be used during the time window, and wherein the link combination has a highest total data throughput sum among link combination candidates each comprising links used in the MLO.

### CROSS-REFERENCE TO RELATED APPLICATION(S)

This application is a continuation application, claiming priority under 35 U.S.C. § 365 (c), of an International application No. PCT/KR2023/010595, filed on Jul. 21, 2023, which is based on and claims the benefit of a Korean patent application number 10-2022-0105645, filed on Aug. 23, 2022, in the Korean Intellectual Property Office, and of a Korean patent application number 10-2022-0119648, filed on Sep. 21, 2022, in the Korean Intellectual Property Office, the disclosure of each of which is incorporated by reference herein in its entirety.

### BACKGROUND

### 1. Field

The disclosure relates to an electronic device and an integrated control method for a multi-link operation (MLO) and a time-averaged specific absorption rate (SAR) (TAS).

### 2. Description of Related Art

The advent of electronic devices such as smartphones, tablet personal computers (PCs), or laptops has increased explosively the demand for high-speed wireless connectivity. Driven by this trend and the growing demand for high-speed wireless connectivity, the Institute of Electrical and Electronics Engineers (IEEE) 802.11 wireless communication standard has become firmly established in the information technology (IT) industry as a representative and universal high-speed wireless communication standard. An initial wireless local area network (LAN) technology developed around 1997 was capable of supporting a transmission speed of up to 1 to 2 megabits per second (Mbps). Since then, it has continued to be developed, based on the demand for faster wireless connections, to new wireless LAN technologies, such as IEEE 802.11n, 802.11ac, or 802.11ax, that increase the transmission speed. Currently, IEEE 802.11 ax, the latest standard, has a maximum transmission speed of several gigabits per second (Gbps).

Thus, a current wireless LAN provides high-speed wireless connectivity to users everywhere in society, not only in private places such as their homes, but also in various public places such as offices, airports, stadiums, or stations. Accordingly, the wireless LAN has greatly influenced people's way of life and culture and has now become a norm in daily life in the modern world.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and an integrated control method for a multi-link operation (MLO) and a time-averaged specific absorption rate (SAR) (TAS).

Additional aspects will be set forth in part in the description which follows and, in part, will be apparent from the description, or may be learned by practice of the presented embodiments.

In accordance with an aspect of the disclosure, an electronic device is provided. The electronic device includes at least one wireless communication circuitry configured to transmit and receive wireless signals, memory storing one or more computer programs, and one or more processors communicatively coupled to the at least one wireless communication circuitry and the memory, wherein the one or more computer programs include computer-executable instructions that, when executed by the one or more processors individually or collectively, cause the electronic device to verify a time-averaged specific absorption rate (SAR) (TAS) backoff regulation value allocated to a multi-link operation (MLO) for a time window, and based on the TAS backoff regulation value, determine a link combination to be used during the time window, and wherein the link combination has a highest total data throughput sum among link combination candidates each comprising links used in the MLO.

In accordance with another aspect of the disclosure, an electronic device is provided. The electronic device includes at least one wireless communication circuitry configured to transmit and receive wireless signals, memory storing one or more computer programs, and one or more processors communicatively coupled to the at least one wireless communication circuitry and the memory, wherein the one or more computer programs include computer-executable instructions that, when executed by the one or more processors individually or collectively, cause the electronic device to perform a traffic identifier (TID)-to-link mapping negotiation with an access point (AP) multi-link device (MLD) (AP MLD) based on a time-averaged specific absorption rate (SAR) (TAS) backoff regulation value allocated to a multi-link operation (MLO) for a time window, and set a per-link transmit power of a link combination to be used during the time window based on a result of the TID-to-link mapping negotiation.

In accordance with still another aspect of the disclosure, an electronic device is provided. The electronic device includes at least one wireless communication circuitry configured to transmit and receive wireless signals, memory storing one or more computer programs, and one or more processors communicatively coupled to the at least one wireless communication circuitry and the memory, wherein the one or more computer programs include computer-executable instructions that, when executed by the one or more processors individually or collectively, cause the electronic device to verify a time-averaged specific absorption rate (SAR) (TAS) backoff regulation value allocated to a multi-link operation (MLO) for a time window, and perform a traffic identifier (TID)-to-link mapping negotiation with an access point (AP) multi-link device (MLD) (AP MLD) based on the TAS backoff regulation value, and wherein, to perform the TID-to-link mapping negotiation, the one or more computer programs further include computer-executable instructions that, when executed by the one or more processors individually or collectively, cause the electronic device to perform the TID-to-link mapping negotiation by configuring a link combination to be used during the time window such that a number of uplinks is less than a number of downlinks.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of a wireless local area network (LAN) system according to an embodiment of the disclosure;

FIG. 2 is a diagram illustrating another example of a wireless LAN system according to an embodiment of the disclosure;

FIG. 3 is a diagram illustrating an example of a link setup operation according to an embodiment of the disclosure;

FIGS. 4A and 4B are diagrams illustrating a specific absorption rate (SAR) backoff protocol according to various embodiments of the disclosure;

FIG. 5 is a diagram illustrating an example of a multi-link operation (MLO) according to an embodiment of the disclosure;

FIG. 6 is a diagram illustrating an example of an MLO according to an embodiment of the disclosure;

FIG. 7 is a diagram illustrating an example of a traffic identifier (TID)-to-link mapping element according to an embodiment of the disclosure;

FIG. 8 is a schematic block diagram illustrating an example of a non-access point (non-AP) multi-link device (MLD) (non-AP MLD) according to an embodiment of the disclosure;

FIGS. 9A and 9B are diagrams illustrating examples of operations of a non-AP MLD to determine a modulation and coding scheme (MCS) for each link and acquire a total data throughput sum for each link combination candidate according to various embodiments of the disclosure;

FIG. 10 is a diagram illustrating an example of a TID-to-link mapping operation synchronized with a start time point of a time window according to an embodiment of the disclosure;

FIGS. 11A and 11B are diagrams illustrating examples of a state of a link established based on a link combination according to various embodiments of the disclosure;

FIGS. 12A, 12B, and 12C are flowcharts illustrating examples of an operating method of a non-AP MLD according to various embodiments of the disclosure; and

FIG. 13 is a block diagram illustrating an example of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

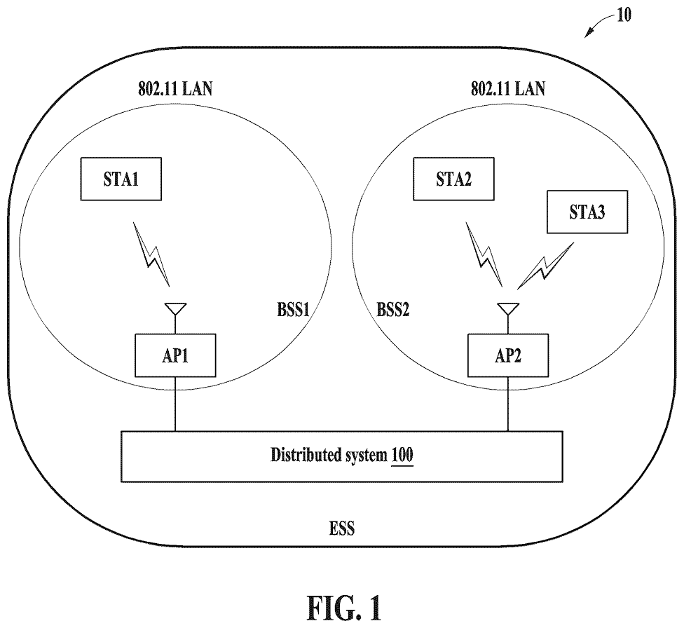

FIG. 1 is a diagram illustrating an example of a wireless local area network (LAN) system according to an embodiment of the disclosure.

Referring to FIG. 1, according to one embodiment, a wireless LAN system 10 may represent an infrastructure mode in which an access point (AP) exists in a wireless LAN (or WLAN) structure under IEEE 802.11 by the Institute of Electrical and Electronics Engineers (IEEE). The wireless LAN system 10 may include at least one basic service set (BSS) (e.g., BSS1 and BSS2). The BSS (BSS1 and BSS2) may refer to a set of APs and stations (STAs) (e.g., electronic device 1301, electronic device 1302, and electronic device 1304 of FIG. 13) that may communicate with each other in synchronization. BSS1 may include AP1 and STA1, and BSS2 may include AP2, STA2, and STA3.

In one embodiment, the wireless LAN system 10 may include at least one STA (e.g., STA1 through STA3), a plurality of APs (e.g., AP1 and AP2) providing a distribution service, and a distributed system 100 connecting the plurality of APs (e.g., AP1 and AP2). The distributed system 100 may connect a plurality of BSSs (e.g., BSS1 and BSS2) to implement an extended service set (ESS). The ESS may be used as a term to refer to a network of a plurality of APs (e.g., AP1 and AP2) connected via the distributed system 100. The plurality of APs (e.g., AP1 and AP2) included in one ESS may have the same service set identifier (SSID).

In one embodiment, the STA (e.g., STA1 through STA3) may be any functional medium that includes a physical layer interface for medium access control (MAC) and wireless media that comply with the specifications of the IEEE 802.11 standard. The STA (e.g., STA1 through STA3) may be used to include both AP and non-AP STAs. The STA (e.g., STA1 through STA3) may also be referred to as various appellations, such as, for example, electronic device, mobile terminal, wireless device, wireless transmit/receive unit (WTRU), user equipment (UE), mobile station (MS), mobile subscriber unit (MSU), or simply user.

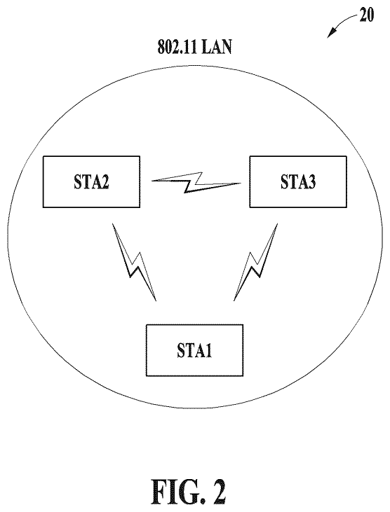

FIG. 2 is a diagram illustrating another example of a wireless LAN system according to an embodiment of the disclosure.

Referring to FIG. 2, according to one embodiment, unlike the wireless LAN system 10 of FIG. 1, a wireless LAN system 20 may represent an ad-hoc mode in which, in a wireless LAN (or WLAN) structure under IEEE 802.11, a network is established between a plurality of STAs (e.g., STA1 through STA3) to perform communication without an AP. The wireless LAN system 20 may include a BSS operating in the ad-hoc mode, i.e., an independent basic service set (IBSS).

In one embodiment, the IBSS may not have a centralized management entity performing a function for management because the IBSS does not include APs. In the IBSS, the STAs may be managed in a distributed manner. In the IBSS, all the STAs may be mobile STAs, and no access to a distributed system is allowed, enabling a self-contained network (or integral network).

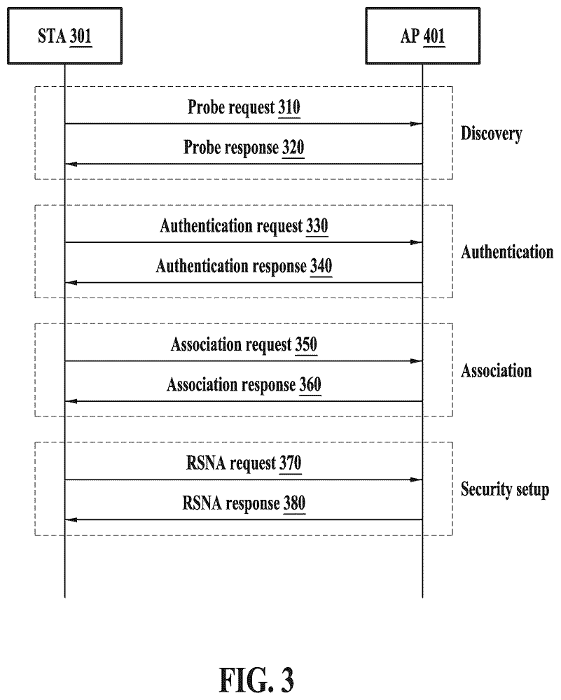

FIG. 3 is a diagram illustrating an example of a link setup operation according to an embodiment of the disclosure.

Referring to FIG. 3, according to one embodiment, a link setup operation may be performed to establish communication between devices (e.g., STA 301 and AP 401) such that they communicate with each other. The link setup operation may include performing network discovery, authentication, association establishment, and security setup operations. The link setup operation may also be referred to as a session initiation operation or a session setup operation. Of the link setup operation, the discovery, authentication, association establishment, and security setup operations may be collectively referred to as an association operation.

In one embodiment, the network discovery operation may include operation 310 and operation 320. At operation 310, an STA 301 (e.g., electronic device 1301, electronic device 1302, or electronic device 1304 of FIG. 13) may transmit a probe request frame to discover which APs are present and may wait for a response to the probe request frame. The STA 301 may perform scanning to access a network to discover a network it may join. The probe request frame may include information of the STA 301 (e.g., device name and/or address of the STA 301). The scanning at operation 310 may refer to active scanning. At operation 320, an AP 401 may transmit a probe response frame in response to the probe request frame to the STA 301 that has transmitted the probe request frame. The probe response frame may include information of the AP 401 (e.g., device name and/or network information of the AP 401). Although the network discovery operation is illustrated in FIG. 3 as being performed through active scanning, it is not necessarily limited thereto, and if the STA 301 performs passive scanning, the operation of transmitting the probe request frame may be omitted. The STA 301 performing passive scanning may receive a beacon frame transmitted from the AP 401 and perform the following operations.

In one embodiment, after the STA 301 discovers the network, the authentication operation including operation 330 and operation 340 may be performed. At operation 330, the STA 301 may transmit an authentication request frame to the AP 401. At operation 340, the AP 401 may determine whether to allow authentication for the corresponding STA 301 based on information included in the authentication request frame. The AP 401 may provide a result of processing the authentication to the STA 301 through an authentication response frame. An authentication frame used for an authentication request/response may correspond to a management frame.

In one embodiment, the authentication frame may include information about an authentication algorithm number, an authentication transaction sequence number, a status code, a challenge text, a robust security network (RSN), or a finite cyclic group.

In one embodiment, after the STA 301 is successfully authenticated, the association operation including operation 350 and operation 360 may be performed. At operation 350, the STA 301 may transmit an association request frame to the AP 401. At operation 360, the AP 401 may transmit an association response frame to the STA 301 in response to the association request frame.

In one embodiment, the association request frame and/or the association response frame may include information related to various capabilities. For example, the association request frame may include information related to various capabilities, such as, beacon listen interval, SSID, supported rates, supported channels, RSN, mobility domain, supported operating classes, traffic indication map (TIM) broadcast request, and/or interworking service capabilities. For example, the association response frame may include information related to various capabilities, such as, status code, association ID (AID), supported rates, enhanced distributed channel access (EDCA) parameter set, received channel power indicator (RCPI), received signal to noise indicator (RSNI), mobility domain, timeout interval (association comeback time), overlapping BSS scan parameters, TIM broadcast response, and/or quality of service (QoS) map.

In one embodiment, after the STA 301 is successfully associated with the network, the security setup operation including operation 370 and operation 380 may be performed. The security setup operation may be performed via a robust security network association (RSNA) request, at operation 370, and an RSNA response, at operation 380. For example, the security setup operation may include performing a private key setup via four-way handshaking over an extensible authentication protocol over LAN (EAPOL) frame. The security setup operation may be performed according to a security scheme not defined by the IEEE 802.11 standard.

In one embodiment, a secure session may be established between the STA 301 and the AP 401 based on the security setup operation, enabling secure data communication between the STA 301 and the AP 401.

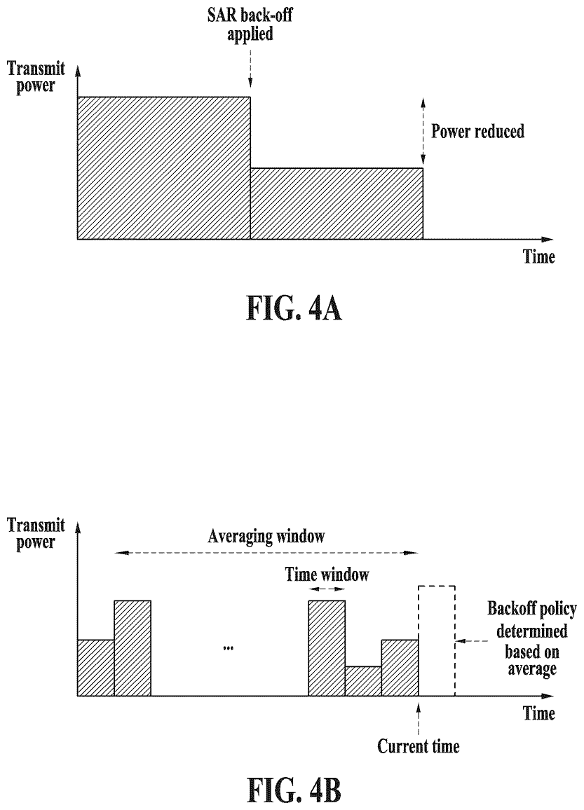

FIGS. 4A and 4B are diagrams illustrating a specific absorption rate (SAR) backoff protocol according to various embodiments of the disclosure.

According to one embodiment, wireless communication may be performed as a transmitting end of an electronic device emits an electromagnetic wave into a wireless medium and a receiving end of an external device receives the emitted electromagnetic wave. In this case, when a human is present in a space where the electromagnetic wave is emitted and received, a significant amount of the electromagnetic wave may be absorbed by the human body. Recent studies show that electromagnetic waves absorbed by the human body may have adverse effects on health. In particular, a closeness of the transmitting and receiving ends to the human body may increase an absorption rate of electromagnetic waves, and accordingly most countries regulate the absorption rate of electromagnetic waves from smart devices. Since most smart devices use a wireless LAN, the wireless LAN is also subject to the regulation. Most countries have defined standards for SAR, a specific absorption rate which refers to an amount of electromagnetic wave energy absorbed by the human body and it is mandatory for smart devices to meet these standards.

Referring to FIG. 4A, according to one embodiment, shown is an example of an SAR backoff protocol performed in response to the regulation on the human absorption of electromagnetic waves. The SAR back off protocol may be a protocol for controlling a transmit power. According to the SAR backoff protocol, a smart device may use a high transmit power when a human body is not determined to be in close proximity. The smart device may also reduce the transmit power when a human body is determined to be in close proximity.

In one embodiment, the smart device may be equipped with multiple connectivity solutions (CSs), such as, LTE and fifth generation (5G), in addition to the wireless LAN. In a case where multiple CSs are operating simultaneously, a sum of electromagnetic wave energy emitted by the respective CSs may be subject to the regulation. In this case, the smart device may reduce the transmit power output by each of the CSs within the limits of its overall energy budget. As described above, controlling the transmit power to meet the regulation on electromagnetic wave energy absorbed by the human body may also be referred to as the SAR backoff protocol. The example of the SAR backoff protocol described with reference to FIG. 4A may be a protocol that uniformly applies a power limit to all transmissions at a certain point in time (e.g., when a human body is in proximity to a device). The effect of electromagnetic waves on a human body may be calculated in terms of a total amount of energy of electromagnetic waves to which the human body is exposed over a period of time. The SAR backoff protocol described with reference to FIG. 4A may be inefficient. For example, in a case where the traffic is very light and very few transmissions are performed, the total amount of electromagnetic waves exposed to a human body may be negligible even if a high transmit power is used. In this case, due to a limit on the transmit power that does not need to be enforced, user experience may be degraded.

Referring to FIG. 4B, according to one embodiment, shown is an example of a SAR backoff protocol (e.g., a time-averaged SAR (TAS) backoff protocol) performed in response to the regulation on the human absorption of electromagnetic waves. The TAS backoff protocol may be a protocol that limits the transmit power in terms of a total amount of electromagnetic wave energy emitted during a certain window (e.g., an averaging window). The TAS backoff protocol limits an average transmit power over the averaging window (e.g., 100 seconds or 60 seconds) to a certain value or less. The TAS backoff protocol may update a TAS backoff regulation value in the unit of a time window much smaller than the averaging window to meet the electromagnetic absorption rate regulation.

In one embodiment, the TAS backoff protocol may calculate, for each time window (or update interval), a sum (e.g., an energy usage for a time window) of products of a transmit time and a transmit power for all transmissions performed during a time window. The TAS backoff protocol may calculate an energy usage of the averaging window by adding together energy usages of time windows included in the averaging window. The TAS backoff protocol may guide the transmit power for a time window such that an average (e.g., average transmit power) acquired by dividing the energy usage of the averaging window by the averaging window meets the regulation. The TAS backoff protocol may calculate an energy budget allocated to each time window. Based on the allocated energy budget for a time window, the TAS backoff protocol may determine whether to perform a TAS backoff operation during that time window. In a case of performing the TAS backoff operation, the TAS backoff protocol may set a TAS backoff regulation value (e.g., a transmit power limit) for a time window. The TAS backoff protocol may calculate the TAS backoff regulation value for the time window by dividing the energy budget allocated to the time window by the size of the time window. The TAS backoff protocol may not unnecessarily limit transmissions in a subsequent time window, even if no substantial transmissions are made during a time window for which a high transmit power is set.

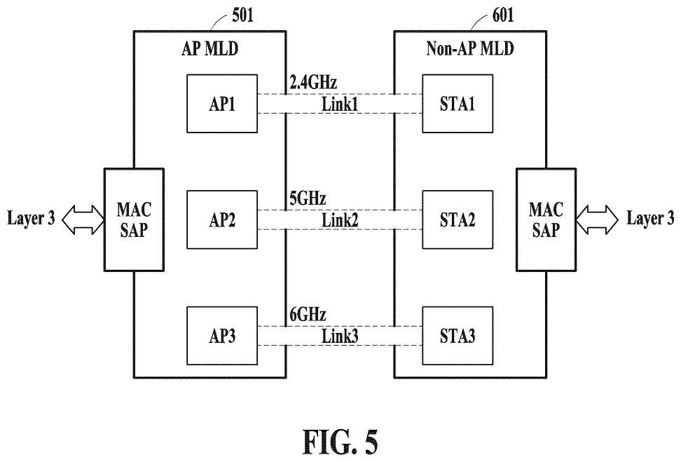

FIG. 5 is a diagram illustrating an example of a multi-link operation (MLO) according to an embodiment of the disclosure.

Referring to FIG. 5, according to one embodiment, an AP multi-link device (MLD) (AP MLD) 501 (e.g., the AP 401 of FIG. 3) and a non-AP MLD 601 (e.g., the STA 301 of FIG. 3) may perform an MLO in which they communicate with each other using a plurality of separate links (e.g., link 1, link 2, and link 3). The AP MLD 501 may be a device including one or more APs (e.g., AP1, AP2, and AP3). The AP MLD 501 may be a device connected to a logical link control (LLC) layer via one interface (e.g., an MAC service access point (SAP)). The one or more APs (e.g., AP1, AP2, and AP3) included in the AP MLD 501 may share some functionality at an MAC layer. The APs in the AP MLD 501 may operate on different links (e.g., AP1 operates on link 1, AP2 operates on link 2, and AP3 operates on link 3). A link may refer to a channel or band. The Aps (e.g., AP1, AP2, and AP3) in the AP MLD 501 may each be responsible for a corresponding link and may act as independent APs.

In one embodiment, the non-AP MLD 601 may be a device including one or more non-APs (e.g., STA1, STA2, and STA3). The non-AP MLD 601 may be a device connected to the LLC layer via one interface (e.g., the MAC SAP). The one or more non-APs (e.g., STA1, STA2, and STA3) included in the non-AP MLD 601 may share some functionality at the MAC layer. The STAs in the non-AP MLD 601 may operate on different links (e.g., STA1 operates on link 1, STA2 operates on link 2, and STA3 operates on link 3). The STAs (e.g., STA1, STA2, and STA3) in the non-AP MLD 601 may each be responsible for a corresponding link and may act as independent STAs. A non-AP MLD used herein may also be referred to as an STA MLD.

In one embodiment, in a case where the AP MLD 501 includes multiple APs (e.g., AP1, AP2, and AP3), the APs (e.g., AP1, AP2, and AP3) may configure separate links (e.g., link 1, link 2, and link 3) to perform frame transmission and reception with respective STAs (e.g., STA1, STA2, and STA3) included in the non-AP MLD 601 using the multiple links. For example, the respective links may operate in 2.4 gigahertz (GHz), 5 GHZ, or 6 GHz band.

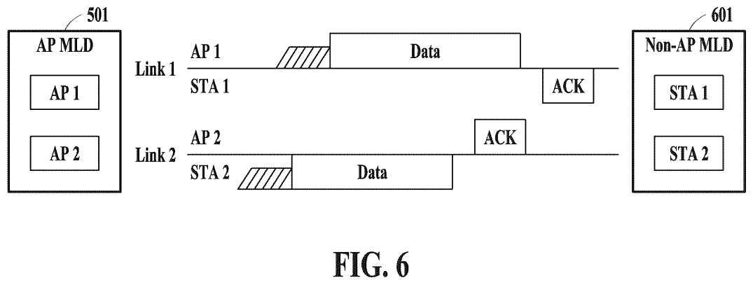

FIG. 6 is a diagram illustrating an example of an MLO according to an embodiment of the disclosure.

Referring to FIG. 6, according to one embodiment, shown is a schematic diagram of communication between an MLD (e.g., the AP MLD 501) (e.g., the AP 401 of FIG. 3) and a non-AP MLD (e.g., the non-AP MLD 601) (e.g., the STA 301 of FIG. 3). The AP MLD 501 and/or the non-AP MLD 601 may transmit uplink data or downlink data through an MLO. The AP MLD 501 may communicate with the non-AP MLD 601 over a plurality of links (e.g., link 1 and link 2). STA 1 of the non-AP MLD 601 may communicate with AP 1 of the AP MLD 501 over link 1. STA 1 of the non-AP MLD 601 may receive data from AP 1 of the AP MLD 501 over link 1. Link 1 may be a downlink. STA 2 of the non-AP MLD 601 may communicate with AP 2 of the AP MLD 501 over link 2. STA 2 of the non-AP MLD 601 may transmit data to AP 2 of the AP MLD 501 over link 2. Link 2 may be an uplink

In one embodiment, a mapping between a traffic identifier (TID) and a link may be established. The TID may be information about a priority of the traffic. A frame corresponding to a TID of a particular value may be exchanged only over a predetermined link. In a case where multiple MLDs (e.g., the AP MLD 501 and the non-AP MLD 601) have performed a negotiation of TID-to-link mapping, or a TID-to-link mapping negotiation, TIDs may be mapped to links. The mapping between the TIDs and the links may be directional-based. For example, link 1 may be set such that a frame corresponding to a first TID is transmitted from AP1 of the AP MLD 501 to STA1 of the non-AP MLD 601. For example, link 2 may be set such that a frame corresponding to a second TID is transmitted from STA2 of the non-AP MLD 601 to AP2 of the AP MLD 501. If no mapping is established between the TIDs and the links, frames corresponding to all the TIDs may be exchanged over any one link.

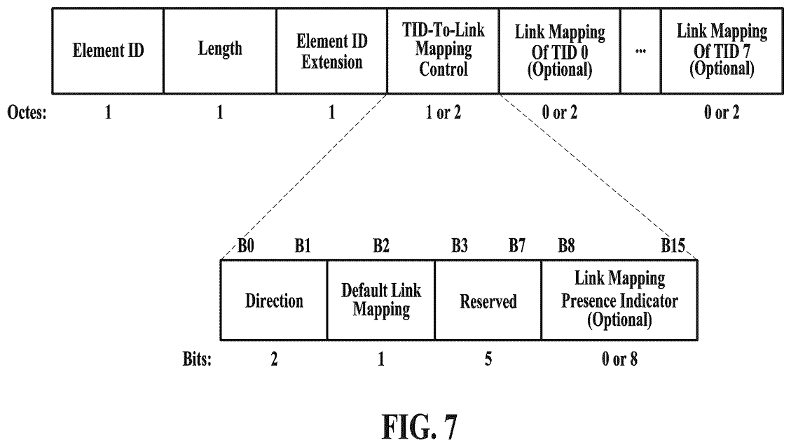

FIG. 7 is a diagram illustrating an example of a TID-to-link mapping element according to an embodiment of the disclosure.

Referring to FIG. 7, according to one embodiment, a TID-to-link mapping element may be in a TID-to-link mapping element format according to IEEE 802.11 (e.g., IEEE 802.11be). The TID-to-link mapping element may include an element ID field (Element ID), a length field (Length), an element ID extension field (Element ID Extension), a TID-to-link mapping control field (TID-to-Link Mapping Control), and a TID-mapped link field (Link Mapping of TID). The TID-to-link mapping control field may include a plurality of subfields, a direction field, a default link mapping field, a reserved field, and a link mapping presence indicator field.

In one embodiment, the direction field (Direction) may be set to zero (0) when the TID-to-link mapping element provides information about a frame transmitted over a downlink. The direction field may be set to 1 when the TID-to-link mapping element provides information about a frame transmitted over an uplink. The direction field may be set to 2 when the TID-to-link mapping element provides information about a frame transmitted over both the downlink and the uplink. The default link mapping field (Default Link Mapping) may be set to 1 when the TID-to-link mapping element represents a default TID-to-link mapping, and may be set to 0 when it does not represent the default TID-to-link mapping. The link mapping presence indicator field (Link Mapping Presence Indicator) may indicate whether there is a TID-mapped link field (or a link mapping of TID) in the TID-to-link mapping element.

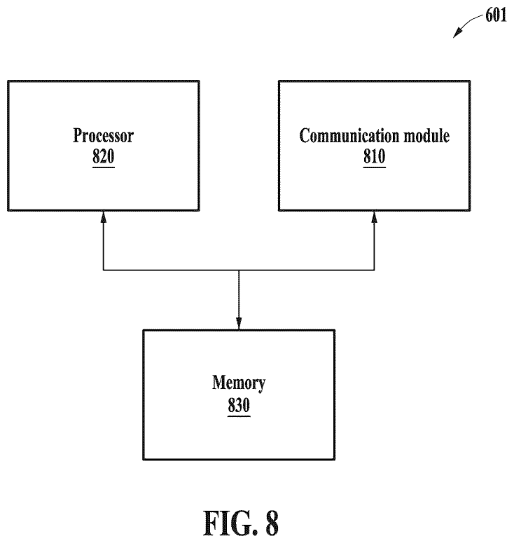

FIG. 8 is a schematic block diagram illustrating an example of a non-AP MLD according to an embodiment of the disclosure.

According to one embodiment, the non-AP MLD 601 (e.g., the STA 301 of FIG. 3) may simultaneously perform the MLO and the TAS backoff protocol. In a Wi-Fi 7 network that supports the MLO and the TAS backoff protocol, an AP MLD (e.g., the AP MLD 501 of FIG. 5) and a non-AP MLD (e.g., the non-AP MLD 601 of FIG. 5) may communicate over a plurality of links. An amount of electromagnetic waves emitted from the non-AP MLD 601 may increase proportionally to the number of links used in the MLO. The non-AP MLD 601 may thus consider this electromagnetic wave emission amount when setting a link. The non-AP MLD 601 may efficiently respond to the electromagnetic wave emission regulation by integrating and controlling the MLO and the TAS backoff protocol.

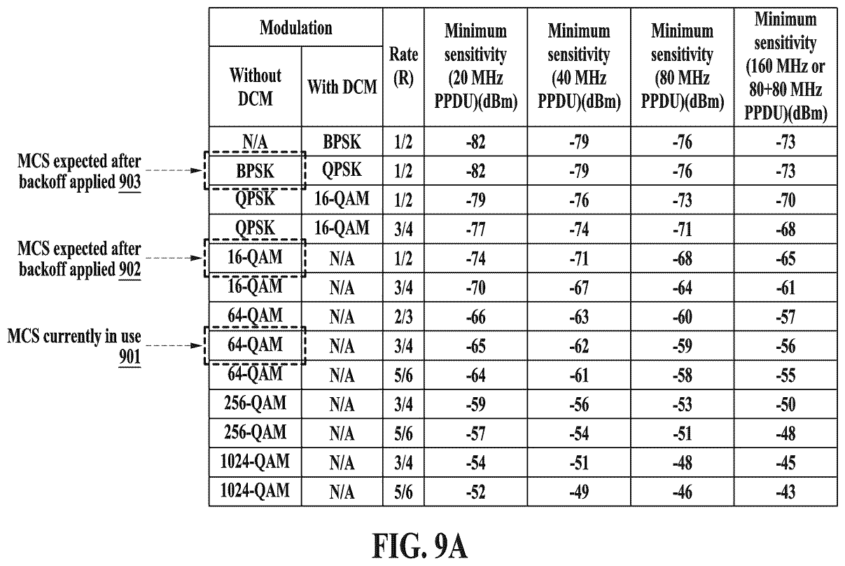

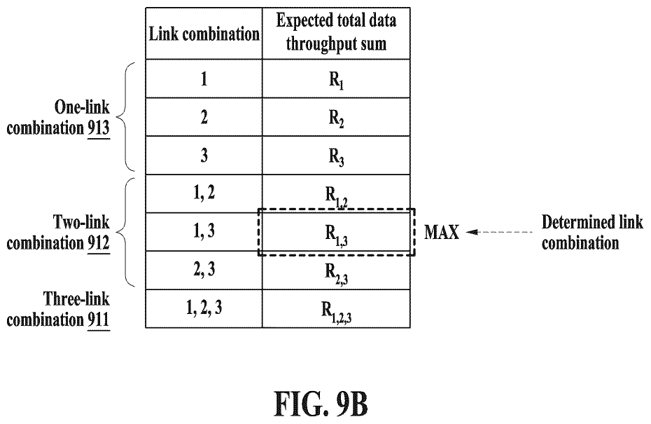

In one embodiment, the non-AP MLD 601 may determine an optimal link combination for performing the MLO in any communication environment, while considering the TAS backoff protocol. A total sum of data throughputs, or a total data throughput sum, of the link combination may change in real time based on a real-time link state. The real-time link state may change in real time, depending on an RSSI of a network and/or an MCS in use. For example, due to small-scale fading, signal attenuation in a given frequency band (e.g., a frequency band corresponding to link 2 of FIG. 9B) at a given location at a given time may be very large. In this case, lowering the transmit power of link 2 may excessively reduce the usability of link 2. Thus, rather than using link 2, increasing the transmit power of another link (e.g., link 1 and/or link 3 of FIG. 9B) and performing communication may be a method to increase the total data throughput sum. Under the SAR backoff protocol (e.g., the TAS backoff protocol), using a small number of links each with a high transmit power may be advantageous, or using a large number of links each with a low transmit power may be advantageous. An optimal link combination may be determined by a total data throughput sum for each link combination. The non-AP MLD 601 may determine a link combination to perform an optimal MLO in any communication environment, while considering the SAR backoff protocol.

Referring to FIG. 8, according to one embodiment, the non-AP MLD 601 may include a wireless communication module 810 (e.g., wireless communication module 1392 of FIG. 13), a processor 820 (e.g., processor 1320 of FIG. 13), and memory 830 (e.g., memory 1330 of FIG. 13). The wireless communication module 810 may be configured to transmit and receive wireless signals. The wireless communication module 810 may be a Wi-Fi chipset. The processor 820 may be operatively connected to the wireless communication module 810. The memory 830 may be electrically connected to the processor 820 and may store instructions executable by the processor 820. The non-AP MLD 601 may correspond to an electronic device (e.g., electronic device 1301 of FIG. 13) described below with reference to FIG. 13. Thus, what is to be described below with reference to FIG. 13 is omitted here.

In one embodiment, the processor 820 may verify a TAS backoff regulation value (e.g., a power limit value allocated to the MLO as a whole) allocated to the MLO for a time window. As described above with reference to FIG. 4B, the TAS backoff regulation value may be a power limit value set for a time window.

In one embodiment, the processor 820 may determine a link combination to be used during the time window based on the TAS backoff regulation value. The link combination may be one that has (e.g., is predicted to have) the highest total data throughput sum, among link combination candidates each including links used in the MLO. The link combination may also include information about links to be used during the time window (e.g., an update interval under the TAS backoff protocol). For example, the link combination may include directional information of the links, an MCS for the links, information about TIDs mapped to the links, and/or the TAS backoff regulation value for the links.

In one embodiment, the processor 820 may determine, for each of the link combination candidates, a TAS backoff regulation value per link, or a per-link TAS backoff regulation value. For example, for a link combination candidate (e.g., a combination of link 1 and link 2), the processor 820 may determine a TAS backoff regulation value for link 1 and a TAS backoff regulation value for link 2. The processor 820 may determine a per-link MCS for each of the link combination candidates, based on the per-link TAS backoff regulation value. For example, for a link combination candidate (e.g., the combination of link 1 and link 2), the processor 820 may determine an MCS for link 1 and an MCS for link 2. A method of determining the per-link MCS is described below with reference to FIG. 9A. The processor 820 may calculate a per-link data throughput for each of the link combination candidates, based on the per-link MCS. For example, for a link combination candidate (e.g., the combination of link 1 and link 2), the processor 820 may calculate a data throughput for link 1 and a data throughput for link 2. The processor 820 may acquire a total data throughput sum for each of the link combination candidates by calculating a sum of the per-link data throughputs. For example, for a link combination candidate (e.g., the combination of link 1 and link 2), the processor 820 may calculate a sum of the data throughput of link 1 and the data throughput of link 2 to acquire a total data throughput sum of the link combination candidate (e.g., the combination of link 1 and link 2). A method of acquiring a total data throughput sum for each link combination candidate is described below with reference to FIG. 9B. The processor 820 may determine, from among the link combination candidates, a link combination candidate having the highest total data throughput sum as the link combination.

In one embodiment, the processor 820 may set links that are not to be used during the time window to a doze state, based on the link combination. The processor 820 may also negotiate TID-to-link mappings, or perform a TID-to-link mapping negotiation, with the AP MLD 501, based on the link combination. A time point for determining the link combination (or a time point for the TID-to-link mapping negotiation) may be synchronized with a start time point of the time window. The link combination may be configured such that the number of uplinks is smaller than the number of downlinks.

FIGS. 9A and 9B are diagrams illustrating examples of operations of a non-AP MLD to determine a per-link MCS and acquire a total data throughput sum for each link combination candidate according to various embodiments of the disclosure.

According to one embodiment, a non-AP MLD (e.g., the non-AP MLD 601 of FIG. 5) may communicate with an AP MLD (e.g., the AP MLD 501 of FIG. 5) over a plurality of links. An amount of electromagnetic wave emitted from the non-AP MLD 601 may increase proportionally to the number of links used in an MLO. As the number of links used in the MLO increases, the transmit power allocated to each of the links may decrease. In terms of transmission speed, using fewer links to which a higher transmit power is allocated may be more effective than using more links to which a lower transmit power is allocated.

Referring to FIG. 9A, according to one embodiment, an MCS corresponding to link “a” may differ based on the number of links used in the MLO. In a situation 901, the non-AP MLD 601 may use a single link a to communicate with the AP MLD 501. In the situation 901, the transmit power allocated to the single link a may be relatively high (e.g., a TAS backoff regulation value allocated to the link a may be high). In the situation 901, an MCS corresponding to the high transmit power allocated to the link a may be 64-quadrature amplitude modulation (QAM). In a situation 902, the non-AP MLD 601 may communicate with the AP MLD 501 using the link a and link b. The transmit power allocated to the link a in the situation 902 may be lower than the transmit power allocated to the link a in the situation 901. An MCS corresponding to the allocated link a in the situation 902 may be 16-QAM. In a situation 903, the non-AP MLD 601 may communicate with the AP MLD 501 using the link a, the link b, and link c. The transmit power allocated to the link a in the situation 903 may be lower than the transmit power allocated to the link a in the situation 902. In the situation 903, an MCS corresponding to the link a may be binary phase-shift keying (BPSK).

Referring to FIG. 9B, according to one embodiment, shown is an example of a total data throughput sum for each of link combination candidates (e.g., three-link combination candidate 911 using three links, two-link combination candidate 912 using two links, and one-link combination candidate 913 using one link) in a case where there are three links (e.g., link 1, link 2, and link 3) available in an MLO. The non-AP MLD 601 may calculate a per-link data throughput for each of the link combination candidates 911, 912, and 913 based on a per-link MCS. The non-AP MLD 601 may calculate a sum of the per-link data throughputs to acquire a total data throughput sum for each of the link combination candidates 911, 912, and 913. The non-AP MLD 601 may determine a link combination candidate with the highest total data throughput sum (e.g., R_{1,3}) to be a link combination (e.g., a combination of link 1 and link 3) from among the link combination candidates 911, 912, and 913.

In one embodiment, a total data throughput sum for the same link combination candidate may change in real time based on a real-time link state. The real-time link state may change in real time, based on an RSSI of a network and/or an MCS in use. For example, due to small-scale fading, signal attenuation in a given frequency band (e.g., a frequency band corresponding to link 2 of FIG. 9B) at a given location at a given time may be very large. In this case, lowering the transmit power of link 2 may excessively reduce the usability of link 2. Thus, rather than using link 2, increasing the transmit power of another link (e.g., link 1 and/or link 3 of FIG. 9B) and using it may be a method to increase the total data throughput sum. Under the SAR backoff protocol (e.g., the TAS backoff protocol), using a small number of links each with a high transmit power may be advantageous, or using a large number of links each with a high transmit power may be advantageous. The non-AP MLD 601 may determine an optimal link combination to perform the MLO in any communication environment while considering the SAR backoff protocol.

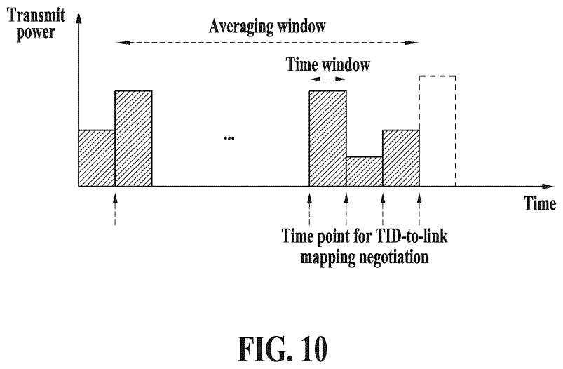

FIG. 10 is a diagram illustrating an example of a TID-to-link mapping operation synchronized with a start time point of a time window according to an embodiment of the disclosure.

Referring to FIG. 10, according to one embodiment, a non-AP MLD (e.g., the non-AP MLD 601 of FIG. 5) may determine a link combination to be used for an MLO at each time window (or update interval) of the TAS backoff protocol. The non-AP MLD 601 may perform a TID-to-link mapping negotiation with an AP MLD (e.g., the AP MLD 501 of FIG. 5) at each time window (or update interval).

In one embodiment, a TAS backoff regulation value may differ for each time window. A link combination having the highest total data throughput sum among link combination candidates may differ for each time window. A time point of the TID-to-link mapping negotiation (and/or a time point of determining the link combination) may be synchronized with a start time point of a time window (or update interval) of the TAS backoff protocol.

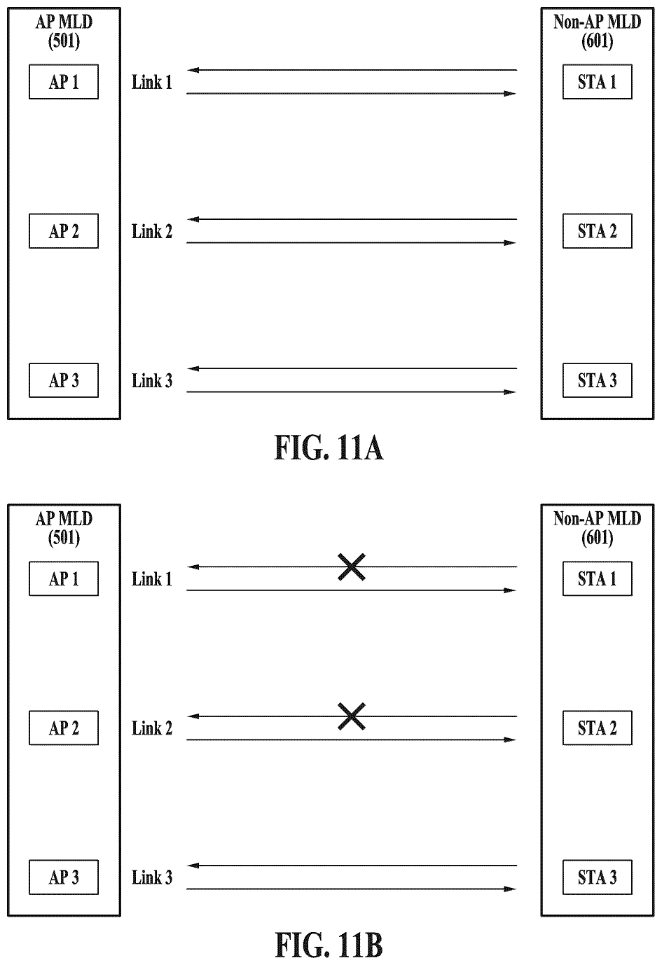

FIGS. 11A and 11B are diagrams illustrating examples of a state of a link established based on a link combination according to various embodiments of the disclosure.

According to one embodiment, a non-AP MLD (e.g., the non-AP MLD 601 of FIG. 5) may communicate with an AP MLD (e.g., the AP MLD 501 of FIG. 5) based on a link combination determined for a time window of the TAS backoff protocol. The non-AP MLD 601 may shift a state of a link that is not to be used during the time window (e.g., a link that is not included in the link combination among multiple links) to a doze state. The non-AP MLD 601 may not use the link not by mapping a TID to the link that is not to be used.

Referring to FIG. 11A, shown is an example case where there are three links (e.g., link 1, link 2, and link 3) available in an MLO between the non-AP MLD 601 and the AP MLD 501.

Referring to FIG. 11B, shown is an example of a link combination configured such that the number of uplinks is less than the number of downlinks. The non-AP MLD 601 may shift a state of links (e.g., an uplink of link 1 and an uplink of link 2) that are not to be used during a time window to the doze state. The non-AP MLD 601 may not map TIDs to the links (e.g., the uplink of link 1 and the uplink of link 2) that are not to be used during the time window. The TAS backoff protocol may be a protocol that regulates an amount of electromagnetic wave emitted by data transmission (or an amount of electromagnetic wave absorbed by a human body). The TAS backoff protocol may be a protocol that regulates an amount of electromagnetic wave emitted by data transmission and reception over an uplink. The non-AP MLD 601 may configure the link combination such that the number of uplinks is smaller than the number of downlinks to meet the SAR regulation while minimizing the degradation of user experience.

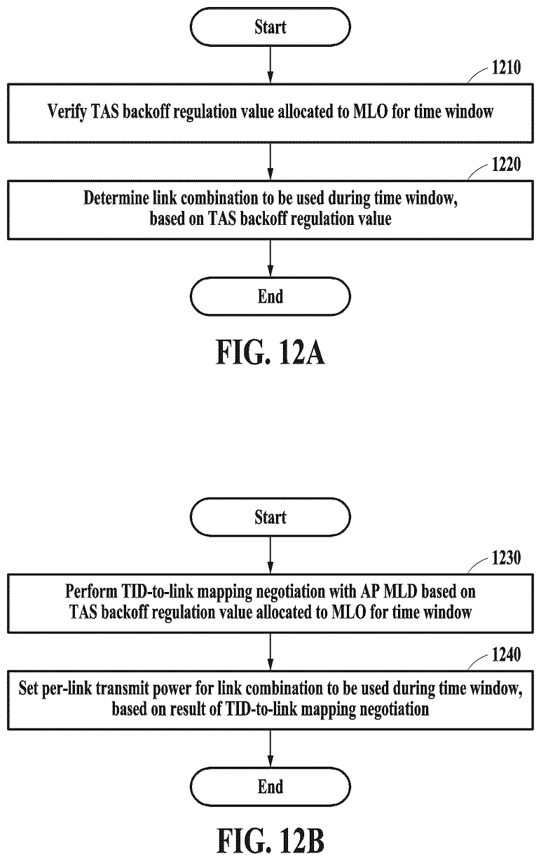

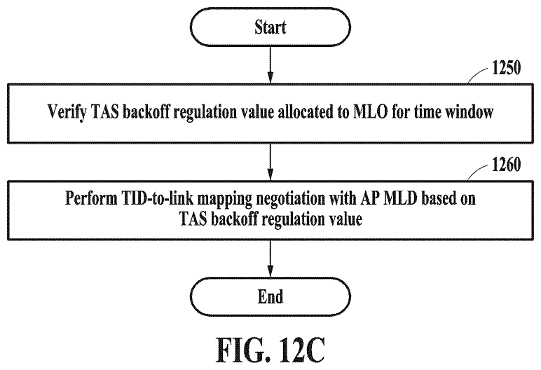

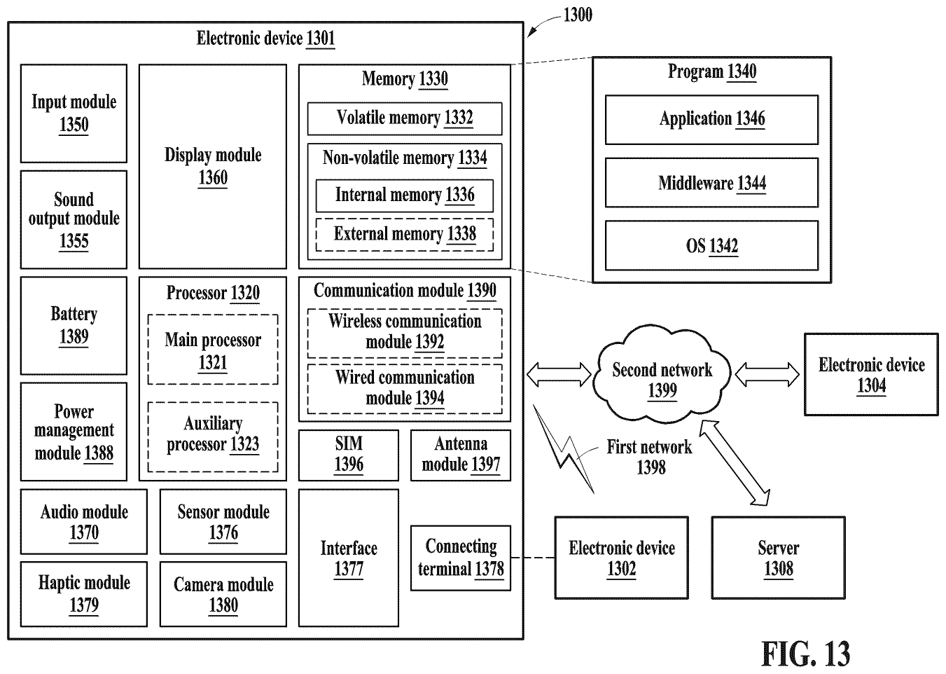

FIG. 12A is a flowchart illustrating an example flow of an operating method of a non-AP MLD according to an embodiment of the disclosure.

Operations 1210 and 1220 may be performed sequentially but are not necessarily performed sequentially. For example, the order of each of the operations 1210 and 1220 may be changed, and at least two of the operations may be performed in parallel.

At operation 1210, a non-AP MLD (e.g., the non-AP MLD 601 of FIG. 5) (e.g., the STA 301 of FIG. 3) may verify a TAS backoff regulation value (e.g., a power limit allocated to an MLO as a whole) allocated to the MLO for a time window. The TAS backoff regulation value may be a power limit value set for a time window (e.g., a time window (or update interval) of the TAS backoff protocol).

At operation 1220, the non-AP MLD 601 may determine a link combination to be used during the time window, based on the TAS backoff regulation value. The link combination may be one that has the highest total data throughput sum, among link combination candidates each including links used in the MLO. A time point at which the link combination is determined may be synchronized with a start time point of the time window. The link combination may be configured such that the number of uplinks is smaller than the number of downlinks.

FIG. 12B is a flowchart illustrating an example flow of an operating method of a non-AP MLD according to an embodiment of the disclosure.

Operations 1230 and 1240 may be performed sequentially but are not necessarily performed sequentially. For example, the order of each of the operations 1230 and 1240 may be changed, and at least two of the operations may be performed in parallel.

At operation 1230, a non-AP MLD (e.g., the non-AP MLD 601 of FIG. 5) (e.g., the STA 301 of FIG. 3) may perform a TID-to-link mapping negotiation with an AP MLD based on a TAS backoff regulation value allocated to an MLO for a time window (e.g., a power limit allocated to the MLO as a whole).

At operation 1240, the non-AP MLD 601 may set a per-link transmit power for a link combination to be used during the time window, based on a result of the TID-to-link mapping negotiation.

FIG. 12C is a flowchart illustrating an example flow of an operating method of a non-AP MLD according to an embodiment of the disclosure.

Operations 1250 and 1260 may be performed sequentially but are not necessarily performed sequentially. For example, the order of each of the operations 1250 and 1260 may be changed, and at least two of the operations may be performed in parallel.

At operation 1250, a non-AP MLD (e.g., the non-AP MLD 601 of FIG. 5) (e.g., the STA 301 of FIG. 3) may verify a TAS backoff regulation value (e.g., a power limit value allocated to an MLO as a whole) allocated to the MLO for a time window.

At operation 1260, the non-AP MLD 601 may perform a TID-to-link mapping negotiation with an AP MLD based on the TAS backoff regulation value. The non-AP MLD 601 may perform the negotiation by configuring a link combination to be used during the time window such that the number of uplinks is greater than the number of downlinks.

FIG. 13 is a block diagram illustrating an example of an electronic device in a network environment according to an embodiment of the disclosure.

Referring to FIG. 13, an electronic device 1301 in a network environment 1300 may communicate with an external electronic device 1302 via a first network 1398 (e.g., a short-range wireless communication network), or communicate with at least one of an external electronic device 1304 and a server 1308 via a second network 1399 (e.g., a long-range wireless communication network). According to an embodiment, the electronic device 1301 may communicate with the external electronic device 1304 via the server 1308. According to an embodiment, the electronic device 1301 may include a processor 1320, memory 1330, an input module 1350, a sound output module 1355, a display module 1360, an audio module 1370, and a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In various embodiments, at least one (e.g., the connecting terminal 1378) of the above components may be omitted from the electronic device 1301, or one or more other components may be added to the electronic device 1301. In various embodiments, some (e.g., the sensor module 1376, the camera module 1380, or the antenna module 1397) of the components may be integrated as a single component (e.g., the display module 1360).

The processor 1320 may execute, for example, software (e.g., a program 1340) to control at least one other component (e.g., a hardware or software component) of the electronic device 1301 connected to the processor 1320 and may perform various data processing or computations. According to an embodiment, as at least a part of data processing or computations, the processor 1320 may store a command or data received from another component (e.g., the sensor module 1376 or the communication module 1390) in volatile memory 1332, process the command or data stored in the volatile memory 1332, and store resulting data in non-volatile memory 1334. According to an embodiment, the processor 1320 may include a main processor 1321 (e.g., a central processing unit (CPU) or an application processor (AP)) or an auxiliary processor 1323 (e.g., a graphics processing unit (GPU), a neural processing unit (NPU), an image signal processor (ISP), a sensor hub processor, or a communication processor (CP)) that is operable independently from or in conjunction with, the main processor 1321. For example, when the electronic device 1301 includes the main processor 1321 and the auxiliary processor 1323, the auxiliary processor 1323 may be adapted to consume less power than the main processor 1321 or to be specific to a specified function. The auxiliary processor 1323 may be implemented separately from the main processor 1321 or as a part of the main processor 1321.

The auxiliary processor 1323 may control at least some of functions or states related to at least one (e.g., the display module 1360, the sensor module 1376, or the communication module 1390) of the components of the electronic device 1301, instead of the main processor 1321 while the main processor 1321 is in an inactive (e.g., sleep) state or along with the main processor 1321 while the main processor 1321 is an active state (e.g., executing an application). According to an embodiment, the auxiliary processor 1323 (e.g., an ISP or a CP) may be implemented as a portion of another component (e.g., the camera module 1380 or the communication module 1390) that is functionally related to the auxiliary processor 1323. According to an embodiment, the auxiliary processor 1323 (e.g., an NPU) may include a hardware structure specifically for artificial intelligence (AI) model processing. An AI model may be generated by machine learning. The machine learning may be performed by, for example, the electronic device 1301, in which the AI model is performed, or performed via a separate server (e.g., the server 1308). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 1330 may store various pieces of data used by at least one component (e.g., the processor 1320 or the sensor module 1376) of the electronic device 1301. The various pieces of data may include, for example, software (e.g., the program 1340) and input data or output data for a command related thereto. The memory 130 may include the volatile memory 1332 or the non-volatile memory 1334. The non-volatile memory 1334 may include internal memory 1336 and external memory 1338.

The program 1340 may be stored as software in the memory 1330 and may include, for example, an operating system (OS) 1342, middleware 1344, or an application 1346.

The input module 1350 may receive, from outside (e.g., a user) the electronic device 1301, a command or data to be used by another component (e.g., the processor 1320) of the electronic device 1301. The input module 1350 may include, for example, a microphone, a mouse, a keyboard, a key (e.g., a button), or a digital pen (e.g., a stylus pen).

The sound output module 1355 may output a sound signal to the outside of the electronic device 1301. The sound output module 1355 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 1360 may visually provide information to the outside (e.g., a user) of the electronic device 1301. The display module 1360 may include, for example, a display, a hologram device, or a projector, and a control circuitry for controlling a corresponding one of the display, the hologram device, and the projector. According to an embodiment, the display module 1360 may include a touch sensor adapted to sense a touch, or a pressure sensor adapted to measure an intensity of a force of the touch.

The audio module 1370 may convert sound into an electric signal or vice versa. According to an embodiment, the audio module 1370 may obtain the sound via the input module 1350 or output the sound via the sound output module 1355 or an external electronic device (e.g., the external electronic device 1302, such as a speaker or headphones) directly or wirelessly connected to the electronic device 1301.

The sensor module 1376 may detect an operational state (e.g., power or temperature) of the electronic device 1301 or an environmental state (e.g., a state of a user) external to the electronic device 1301 and generate an electric signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used by the electronic device 1301 to couple with an external electronic device (e.g., the external electronic device 1302) directly (e.g., by wire) or wirelessly. According to an embodiment, the interface 1377 may include, for example, a high-definition multimedia interface (HDMI), a universal serial bus (USB) interface, a secure digital (SD) card interface, or an audio interface.

The connecting terminal 1378 may include a connector via which the electronic device 1301 may physically connect to an external electronic device (e.g., the external electronic device 1302). According to an embodiment, the connecting terminal 1378 may include, for example, an HDMI connector, a USB connector, an SD card connector, or an audio connector (e.g., a headphones connector).

The haptic module 1379 may convert an electric signal into a mechanical stimulus (e.g., a vibration or a movement) or an electrical stimulus, which may be recognized by a user via their tactile sensation or kinesthetic sensation. According to an embodiment, the haptic module 1379 may include, for example, a motor, a piezoelectric element, or an electric stimulator.

The camera module 1380 may capture a still image and moving images. According to an embodiment, the camera module 1380 may include one or more lenses, image sensors, ISPs, and flashes.

The power management module 1388 may manage power supplied to the electronic device 1301. According to an embodiment, the power management module 1388 may be implemented as, for example, at least a part of a power management integrated circuit (PMIC).

The battery 1389 may supply power to at least one component of the electronic device 1301. According to an embodiment, the battery 1389 may include, for example, a primary cell, which is not rechargeable, a secondary cell, which is rechargeable, or a fuel cell.

The communication module 1390 may support establishing a direct (e.g., wired) communication channel or a wireless communication channel between the electronic device 1301 and an external electronic device (e.g., the external electronic device 1302, the external electronic device 1304, or the server 1308) and performing communication via the established communication channel. The communication module 1390 may include one or more CPs that are operable independently from the processor 1320 (e.g., an AP) and that support direct (e.g., wired) communication or wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device, for example, the external electronic device 1304, via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a fifth generation (5G) network, a next-generation communication network, the Internet, or a computer network (e.g., an LAN or a wide area network (WAN)). These various types of communication modules may be implemented as a single component (e.g., a single chip), or may be implemented as multiple components (e.g., multiple chips) separate from each other. The wireless communication module 1392 may identify and authenticate the electronic device 1301 in a communication network, such as the first network 198 or the second network 1399, using subscriber information (e.g., international mobile subscriber identity (IMSI)) stored in the SIM 1396.

The wireless communication module 1392 may support a 5G network after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., a millimeter wave (mmWave) band) to achieve, e.g., a high data transmission rate. The wireless communication module 1392 may support various technologies for securing performance on a high-frequency band, such as, e.g., beamforming, massive multiple-input and multiple-output (MIMO), full dimensional MIMO (FD-MIMO), an antenna array, analog beamforming, or a large-scale antenna. The wireless communication module 1392 may support various requirements specified in the electronic device 1301, an external electronic device (e.g., the external electronic device 1304), or a network system (e.g., the second network 1399). According to an embodiment, the wireless communication module 1392 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 1397 may transmit or receive a signal or power to or from the outside (e.g., an external electronic device) of the electronic device 1301. According to an embodiment, the antenna module 1397 may include an antenna including a radiating element including a conductive material or a conductive pattern formed in or on a substrate (e.g., a printed circuit board (PCB)). According to an embodiment, the antenna module 1397 may include a plurality of antennas (e.g., an antenna array). In such a case, at least one antenna appropriate for a communication scheme used in a communication network, such as the first network 1398 or the second network 1399, may be selected by, for example, the communication module 1390 from the plurality of antennas. The signal or power may be transmitted or received between the communication module 1390 and the external electronic device via the at least one selected antenna. According to an embodiment, another component (e.g., a radio frequency integrated circuit (RFIC)) other than the radiating element may be additionally formed as a part of the antenna module 1397.

According to various embodiments, the antenna module 1397 may form an mmWave antenna module. According to an embodiment, the mmWave antenna module may include a PCB, an RFIC on a first surface (e.g., a bottom surface) of the PCB, or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the above-described components may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 1301 and the external electronic device (e.g., the external electronic device 1304) via the server 1308 coupled with the second network 1399. Each of the external electronic devices (e.g., the external electronic device 1302 and 1304) may be a device of the same type as or a different type from the electronic device 1301. According to an embodiment, some or all the operations to be executed by the electronic device 1301 may be executed by one or more of the external electronic devices (e.g., the external electronic devices 1302 and 1304, and the server 1308). For example, if the electronic device 1301 needs to perform a function or a service automatically, or in response to a request from a user or another device, the electronic device 1301, instead of, or in addition to, executing the function or the service, may request one or more external electronic devices to perform at least a part of the function or service. The one or more external electronic devices receiving the request may perform the at least part of the function or service requested, or an additional function or an additional service related to the request, and may transfer a result of the performance to the electronic device 1301. The electronic device 1301 may provide the result, with or without further processing of the result, as at least a part of a response to the request. To that end, cloud computing, distributed computing, mobile edge computing (MEC), or client-server computing technology may be used, for example. The electronic device 1301 may provide ultra-low latency services using, e.g., distributed computing or MEC. In an embodiment, the external electronic device (e.g., the external electronic device 1304) may include an Internet-of-things (IoT) device. The server 1308 may be an intelligent server using machine learning and/or a neural network. According to an embodiment, the external electronic device (e.g., the external electronic device 1304) or the server 1308 may be included in the second network 1399. The electronic device 1301 may be applied to intelligent services (e.g., a smart home, a smart city, a smart car, or healthcare) based on 5G communication technology or IoT-related technology.

According to various embodiments described herein, an electronic device may be a device of one of various types. The electronic device may include, as non-limiting examples, a portable communication device (e.g., a smartphone, etc.), a computing device, a portable multimedia device, a portable medical device, a camera, a wearable device, or a home appliance. However, the electronic device is not limited to the examples described above.

It should be appreciated that various embodiments of the disclosure and the terms used therein are not intended to limit the technological features set forth herein to particular embodiments and include various changes, equivalents, or replacements for a corresponding embodiment. As used herein, “A or B,” “at least one of A and B,” “at least one of A or B,” “A, B, or C,” “at least one of A, B, and C,” and “A, B, or C,” each of which may include any one of the items listed together in the corresponding one of the phrases, or all possible combinations thereof. Terms such as “first,” “second,” or “initial” or “next” or “subsequent” may simply be used to distinguish the component from other components in question, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments set forth herein may be implemented as software (e.g., the program 1340) including one or more instructions that are stored in a storage medium (e.g., the internal memory 1336 or the external memory 1338) that is readable by a machine (e.g., the electronic device 1301). For example, a processor (e.g., the processor 1320) of a device (e.g., the electronic device 1301) may invoke at least one of the one or more instructions stored in the storage medium and execute it. This allows the machine to be operated to perform at least one function according to the at least one instruction invoked. The one or more instructions may include code generated by a complier or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments, a method according to an embodiment of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™) or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to one embodiment, an electronic device (e.g., the STA 301 of FIG. 3, the non-AP MLD 601 of FIG. 6, and the electronic device 1301 of FIG. 13) may include at least one wireless communication circuitry (e.g., the wireless communication module 810 of FIG. 8 and the wireless communication module 1392 of FIG. 13) configured to transmit and receive wireless signals, memory (e.g., the memory 830 of FIG. 8 and the memory 1330 of FIG. 13) storing one or more computer programs, one or more processors (e.g., the processor 820 of FIG. 8 and the processor 1320 of FIG. 13) operatively connected to the wireless communication circuitry 810 and the memory 830. The one or more computer programs include computer-executable instructions that, when executed by the one or more processors 820 individually or collectively, cause the electronic device to perform a TID-to-link mapping negotiation with an AP MLD based on a TAS backoff regulation value allocated to an MLO for a time window. The one or more computer programs include computer-executable instructions that, when executed by the one or more processors 820 individually or collectively, cause the electronic device to set a per-link transmit power of a link combination to be used during the time window based on a result of the negotiation.

In one embodiment, a time point for determining the link combination may be synchronized with a start time point of the time window.

In one embodiment, the link combination may be configured such that a number of uplinks is less than a number of downlinks.

In one embodiment, the one or more computer programs further include computer-executable instructions that, when executed by the one or more processors 820 individually or collectively, cause the electronic device to perform the TID-to-link mapping negotiation with the AP MLD based on the link combination.

In one embodiment, the one or more computer programs further include computer-executable instructions that, when executed by the one or more processors 820 individually or collectively, cause the electronic device to set a link that is not to be used during the time window to a doze state, based on the link combination.

In one embodiment, to determine the link combination, the one or more computer programs include computer-executable instructions that, when executed by the one or more processors 820 individually or collectively, cause the electronic device to determine a per-link TAS backoff regulation value for each of the link combination candidates. To determine the link combination, the one or more computer programs include computer-executable instructions that, when executed by the one or more processors 820 individually or collectively, cause the electronic device to determine a per-link MCS for each of the link combination candidates, based on the per-link TAS backoff regulation value.

In one embodiment, to determine the link combination, the one or more computer programs further include computer-executable instructions that, when executed by the one or more processors 820 individually or collectively, cause the electronic device to calculate a per-link data throughput for each of the link combination candidates, based on the per-link MCS. To determine the link combination, the one or more computer programs further include computer-executable instructions that, when executed by the one or more processors 820 individually or collectively, cause the electronic device to acquire a total data throughput sum for each of the link combination candidates by calculating a sum of per-link data throughputs for each of the link combination candidates.

According to one embodiment, an electronic device (e.g., the STA 301 of FIG. 3, the non-AP MLD 601 of FIG. 6, and the electronic device 1301 of FIG. 13) may include at least one wireless communication circuitry (e.g., the wireless communication module 810 of FIG. 8 and the wireless communication module 1392 of FIG. 13) configured to transmit and receive wireless signals, memory (e.g., the memory 830 of FIG. 8 and the memory 1330 of FIG. 13) storing one or more computer programs, one or more processors (e.g., the processor 820 of FIG. 8 and the processor 1320 of FIG. 13) operatively connected to the wireless communication circuitry 810 and the memory 830. The one or more computer programs include computer-executable instructions that, when executed by the one or more processors 820 individually or collectively, cause the electronic device to perform a TID-to-link mapping negotiation with an AP MLD based on a TAS backoff regulation value allocated to an MLO for a time window. The one or more computer programs include computer-executable instructions that, when executed by the one or more processors 820 individually or collectively, cause the electronic device to set a per-link transmit power of a link combination to be used during the time window based on a result of the TID-to-link mapping negotiation.

In one embodiment, the link combination may be one that has a highest total data throughput sum, among link combination candidates each including links used in the MLO.

In one embodiment, a time point of the TID-to-link mapping negotiation may be synchronized with a start time point of the time window.

In one embodiment, the one or more computer programs further include computer-executable instructions that, when executed by the one or more processors 820 individually or collectively, cause the electronic device to set a link that is not to be used during the time window to a doze state, based on the link combination.

In one embodiment, to perform the TID-to-link mapping negotiation, the one or more computer programs further include computer-executable instructions that, when executed by the one or more processors 820 individually or collectively, cause the electronic device to determine a per-link TAS backoff regulation value for each of the link combination candidates. To perform the TID-to-link mapping negotiation, the one or more computer programs further include computer-executable instructions that, when executed by the one or more processors 820 individually or collectively, cause the electronic device to determine a per-link MCS for each of the link combination candidates, based on the per-link TAS backoff regulation value.

In one embodiment, to perform the TID-to-link mapping negotiation, the one or more computer programs further include computer-executable instructions that, when executed by the one or more processors 820 individually or collectively, cause the electronic device to calculate a per-link data throughput for each of the link combination candidates, based on the per-link MCS. To perform the TID-to-link mapping negotiation, the one or more computer programs further include computer-executable instructions that, when executed by the one or more processors 820 individually or collectively, cause the electronic device to acquire a total data throughput sum for each of the link combination candidates by calculating a sum of per-link data throughputs for each of the link combination candidates.

According to one embodiment, an electronic device (e.g., the STA 301 of FIG. 3, the non-AP MLD 601 of FIG. 6, and the electronic device 1301 of FIG. 13) may include at least one wireless communication circuitry (e.g., the wireless communication module 810 of FIG. 8 and the wireless communication module 1392 of FIG. 13) configured to transmit and receive wireless signals, memory (e.g., the memory 830 of FIG. 8 and the memory 1330 of FIG. 13) storing one or more computer programs, one or more processors (e.g., the processor 820 of FIG. 8 and the processor 1320 of FIG. 13) operatively connected to the wireless communication circuitry 810 and the memory 830. The one or more computer programs include computer-executable instructions that, when executed by the one or more processors 820 individually or collectively, cause the electronic device to verify a TAS backoff regulation value allocated to an MLO for a time window. The one or more computer programs include computer-executable instructions that, when executed by the one or more processors 820 individually or collectively, cause the electronic device to perform a TID-to-link mapping negotiation with an AP MLD based on the TAS backoff regulation value.

In one embodiment, the link combination may be one that has a highest total data throughput sum, among link combination candidates each including links used in the MLO.

In one embodiment, a time point of the TID-to-link mapping negotiation may be synchronized with a start time point of the time window.

In one embodiment, the one or more computer programs include computer-executable instructions that, when executed by the one or more processors 820 individually or collectively, cause the electronic device to set a link that is not to be used during the time window to a doze state, based on the link combination.

In one embodiment, to perform the TID-to-link mapping negotiation, the one or more computer programs further include computer-executable instructions that, when executed by the one or more processors 820 individually or collectively, cause the electronic device to determine a per-link TAS backoff regulation value for each of the link combination candidates. To perform the TID-to-link mapping negotiation, the one or more computer programs further include computer-executable instructions that, when executed by the one or more processors 820 individually or collectively, cause the electronic device to determine a per-link MCS for each of the link combination candidates, based on the per-link TAS backoff regulation value.

In one embodiment, to perform the TID-to-link mapping negotiation, the one or more computer programs further include computer-executable instructions that, when executed by the one or more processors 820 individually or collectively, cause the electronic device to calculate a per-link data throughput for each of the link combination candidates, based on the per-link MCS. To perform the TID-to-link mapping negotiation, the one or more computer programs further include computer-executable instructions that, when executed by the one or more processors 820 individually or collectively, cause the electronic device to acquire a total data throughput sum for each of the link combination candidates by calculating a sum of per-link data throughputs for each of the link combination candidates.

In one embodiment, the total data throughput sum for each of the link combination candidates may vary in real time based on a real-time link state.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one wireless communication circuitry configured to transmit and receive wireless signals;
memory storing one or more computer programs; and
one or more processors communicatively coupled to the at least one wireless communication circuitry and the memory,
wherein the one or more computer programs include computer-executable instructions that, when executed by the one or more processors individually or collectively, cause the electronic device to:
verify a time-averaged specific absorption rate (SAR) (TAS) backoff regulation value allocated to a multi-link operation (MLO) for a time window, and
based on the TAS backoff regulation value, determine a link combination to be used during the time window, and
wherein the link combination has a highest total data throughput sum among link combination candidates each comprising links used in the MLO.

2. The electronic device of claim 1, wherein a time point for determining the link combination is synchronized with a start time point of the time window.

3. The electronic device of claim 1, wherein the link combination is configured such that a number of uplinks is less than a number of downlinks.

4. The electronic device of claim 1, wherein the one or more computer programs further include computer-executable instructions that, when executed by the one or more processors individually or collectively, cause the electronic device to:
perform a traffic identifier (TID)-to-link mapping negotiation with an access point (AP) multi-link device (MLD) (AP MLD) based on the link combination.

5. The electronic device of claim 1, wherein the one or more computer programs further include computer-executable instructions that, when executed by the one or more processors individually or collectively, cause the electronic device to:
set a link that is not to be used during the time window to a doze state based on the link combination.

6. The electronic device of claim 1, wherein, to determine the link combination, the one or more computer programs further include computer-executable instructions that, when executed by the one or more processors individually or collectively, cause the electronic device to:
determine a per-link TAS backoff regulation value for each of the link combination candidates, and
determine a per-link modulation and coding scheme (MCS) for each of the link combination candidates based on the per-link TAS backoff regulation value.

7. The electronic device of claim 6, wherein, to determine the link combination, the one or more computer programs further include computer-executable instructions that, when executed by the one or more processors individually or collectively, cause the electronic device to:
calculate a per-link data throughput for each of the link combination candidates based on the per-link MCS, and
acquire a total data throughput sum for each of the link combination candidates by calculating a sum of the per-link data throughput for each of the link combination candidates.

8. An electronic device comprising:
at least one wireless communication circuitry configured to transmit and receive wireless signals;
memory storing one or more computer programs; and
one or more processors communicatively coupled to the at least one wireless communication circuitry and the memory,
wherein the one or more computer programs include computer-executable instructions that, when executed by the one or more processors individually or collectively, cause the electronic device to:
perform a traffic identifier (TID)-to-link mapping negotiation with an access point (AP) multi-link device (MLD) (AP MLD) based on a time-averaged specific absorption rate (SAR) (TAS) backoff regulation value allocated to a multi-link operation (MLO) for a time window, and
set a per-link transmit power of a link combination to be used during the time window based on a result of the TID-to-link mapping negotiation.

9. The electronic device of claim 8, wherein the link combination has a highest total data throughput sum among link combination candidates each comprising links used in the MLO.

10. The electronic device of claim 8, wherein a time point of the TID-to-link mapping negotiation is synchronized with a start time point of the time window.

11. The electronic device of claim 8, wherein the one or more computer programs further include computer-executable instructions that, when executed by the one or more processors individually or collectively, cause the electronic device to:
set a link that is not to be used during the time window to a doze state based on the link combination.

12. The electronic device of claim 9, wherein, to perform the TID-to-link mapping negotiation, the one or more computer programs further include computer-executable instructions that, when executed by the one or more processors individually or collectively, cause the electronic device to:
determine a per-link TAS backoff regulation value for each of the link combination candidates, and
determine a per-link modulation and coding scheme (MCS) for each of the link combination candidates based on the per-link TAS backoff regulation value.

13. The electronic device of claim 12, wherein, to perform the TID-to-link mapping negotiation, the one or more computer programs further include computer-executable instructions that, when executed by the one or more processors individually or collectively, cause the electronic device to:
calculate a per-link data throughput for each of the link combination candidates based on the per-link MCS, and
acquire a total data throughput sum for each of the link combination candidates by calculating a sum of the per-link data throughput for each of the link combination candidates.

14. An electronic device comprising:
at least one wireless communication circuitry configured to transmit and receive wireless signals;
memory storing one or more computer programs; and
one or more processors communicatively coupled to the at least one wireless communication circuitry and the memory,
wherein the one or more computer programs include computer-executable instructions that, when executed by the one or more processors individually or collectively, cause the electronic device to:
verify a time-averaged specific absorption rate (SAR) (TAS) backoff regulation value allocated to a multi-link operation (MLO) for a time window, and
perform a traffic identifier (TID)-to-link mapping negotiation with an access point (AP) multi-link device (MLD) (AP MLD) based on the TAS backoff regulation value, and
wherein, to perform the TID-to-link mapping negotiation, the one or more computer programs further include computer-executable instructions that, when executed by the one or more processors individually or collectively, cause the electronic device to:
perform the TID-to-link mapping negotiation by configuring a link combination to be used during the time window such that a number of uplinks is less than a number of downlinks.

15. The electronic device of claim 14, wherein the link combination has a highest total data throughput sum among link combination candidates each comprising links used in the MLO.

16. The electronic device of claim 15, wherein, to configure the link combination, the one or more computer programs further include computer-executable instructions that, when executed by the one or more processors individually or collectively, cause the electronic device to:
determine a per-link TAS backoff regulation value for each of the link combination candidates, and
determine a per-link modulation and coding scheme (MCS) for each of the link combination candidates based on the per-link TAS backoff regulation value.

17. The electronic device of claim 16, wherein, to configure the link combination, the one or more computer programs further include computer-executable instructions that, when executed by the one or more processors individually or collectively, cause the electronic device to:
calculate a per-link data throughput for each of the link combination candidates based on the per-link MCS, and
acquire a total data throughput sum for each of the link combination candidates by calculating a sum of the per-link data throughput for each of the link combination candidates.

18. The electronic device of claim 14, wherein a time point for configuring the link combination is synchronized with a start time point of the time window.

19. The electronic device of claim 14, wherein the one or more computer programs further include computer-executable instructions that, when executed by the one or more processors individually or collectively, cause the electronic device to:
set a link that is not to be used during the time window to a doze state based on the link combination.
